(19) United States
(12) Patent Application Publication
(10) Pub. No.: US 2009/0020472 A1
(43) Pub. Date: Jan. 22, 2009

(54) PLEATED FILTER

(75) Inventors: Jeffrey A. Lucas, Clinton, CT (US); Richard D. Sale, Tolland, CT (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/780,256

(22) Filed: Jul. 19, 2007

(51) Int. Cl. B01D 27/14; B21D 39/00

(52) U.S. Cl. 210/458; 29/428

(57) ABSTRACT

The present invention provides novel concentric filter elements that have advantages over traditional concentrically arranged filters as well as filters comprising a single cylindrical filter element.

### TECHNICAL FIELD

The present disclosure relates to a pleated filter. More particularly, the disclosure relates to concentric filter elements.

### BACKGROUND

Traditional cylindrical pleated filters comprise a number of interconnected rectangular panels with short sides extending radially with respect to the axis of the filter element, and long sides extending axially between the ends of the filter element. The maximum number of pleats in a traditional cylindrical pleated filter is determined by the inner circumference of the filter divided by the thickness of the pleats.

Improvements on the traditional radial pleated filter are disclosed in U.S. Pat. No. 2,627,350 (1953) and more recently in U.S. Pat. No. 6,315,130 (2001). The improved configurations provided a design wherein more filtering media can be folded into the same size housing as compared to the traditional cylindrical pleated filters. The term filter media is used herein to generally refer to the materials that can be used for filtering. The filter media can also include materials that primarily provided structural rigidity/support for the filtering material and provide flow channels into and out of the pleat.

Another pleated filtering configuration includes concentrically arranged cylindrical pleated filters elements. An example of a concentrically arranged pleated filter is disclosed in U.S. Pat. No. 5,232,595 to Meyer. One limitation associated with the concentric pleated filter configuration relates to the geometric constraints associated with the cylindrical pleated elements used to construct the concentrically arranged filters.

The present disclosure provides novel concentric filter elements that have advantages over traditional concentrically arranged filters and filters comprising a single cylindrical filter element.

### SUMMARY

The present disclosure provides a cylindrical filter arrangement and a method of manufacturing a multi element filter. In one embodiment of the filter, the filter includes concentrically arranged cylindrical pleated filter elements, wherein one of the filter elements comprises a plurality of outwardly extending primary pleats positioned between shorter inwardly extending secondary pleats. In one embodiment of the manufacturing method, the method includes configuring concentrically arranged inner and outer filter elements such that their estimated effective lives are about the same for the type of fluid to be filtered.

### BRIEF DESCRIPTION OF THE FIGURES

FIG. 1 is a schematic perspective view of a concentric filter arrangement according to the principles of the present disclosure;

FIG. 2 is a top schematic view of an alternative embodiment of the filter of FIG. 1;

FIG. 3 is a perspective schematic view of a single element cylindrical filter;

FIG. 4 is a top schematic view of an alternative embodiment of the filter of FIG. 1;

FIG. 5 is a schematic illustration of the filter of FIG. 4 in a housing; and

FIG. 6 is a portion of a top view of an alternative embodiment of the filter of FIG. 1.

While the above-identified figures set forth several exemplary embodiments of the disclosure, other embodiments are also contemplated. The figures are not drawn to scale.

### DETAILED DESCRIPTION

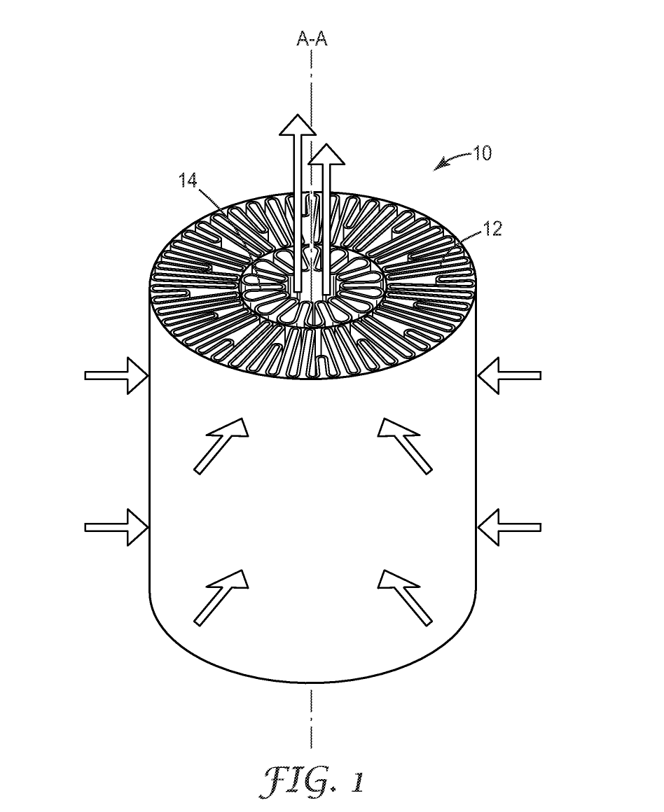

FIG. 1 illustrates fluid flow through a filter arrangement 10 according to one embodiment of the present disclosure. The depicted embodiment includes an outer filter element 12 and an inner filter element 14 that are arranged so that they share the same central axis A-A. In the depicted embodiment both the inner element 14 and the outer element 12 are generally cylindrical having ring-shaped end profiles. The inner element 14 is positioned at least partially within the outer element 12. In the depicted embodiment the fluid is shown flowing into the filter arrangement 10 through the sides of the outer filter 12 and out of the filter arrangement 10 through the center of the inner filter element 14. In such an embodiment the outer filter element 12 acts as a pre-filter and the inner filter element 14 can act as a final filter.

It should be appreciated that many alternative geometric configurations and arrangements are also possible. For example, in an alternative embodiment there could be more than two filter elements (e.g., three, four, five, etc.), one or more of the elements may be non-cylindrical (e.g., elliptical), the inner element could have a solid end profile rather than an annular end profile, and other structures may be incorporated within or around the filter elements. It should also be appreciated that the fluid could be configured to flow in the opposite direction as shown. In such an embodiment the inner filter element 14 could act as a pre-filter and the outer filter element 12 could act as a final filter.

The filter media used to construct the inner and outer filter elements 14, 12 can be the same or they can be different. In particular embodiments it can be advantageous that the material be different. For example, in the depicted embodiment the outer filter element 12 may be constructed of a material with greater average pore size than the material used to construct the inner filter element 14. In such an embodiment the outer filter element 12 would be primarily used to remove larger particulate matter, whereas the inner filter element could be primarily used to remove the smaller particulate matter. A variety of different material could be used in the construction of the inner and other filter element. For example, non-woven (e.g, melt blown material, wet laid glass fibers, cellulosic depth media) or micro porous membranes can be used to construct the filter media (e.g., nylon, poly(vinylidene diflouride) (PVDF), polyethersulfone, poly(tetrafluoroethylene) (PTFE), polypropylene, polyethylene, etc.). In one particular embodiment the outer filter element 12 is constructed of a material commercially available from Lydall Filtration, Manchester, Conn. having “D” series grade, a base weight of about 82 g/m², thickness of about 0.45 mm, and mean flow pore of about 7.5 μm, and the inner filter element 14 is constructed of a micro porous membrane having an average pore size of about 0.2 microns. The materials can be chosen so that the filter arrangement 10 is suited for particular purposes and/or so that the filter has a particular geometric configuration. For example, the micro porous membranes in an alternative embodiment could alternatively have an average pore size of about 0.1 or about 10 microns.

Typically, the ratio between the outer diameter of the outer pleated filter element and an inner diameter of the outer pleated filter element is equal to or less than 1.5 to 1. For example, see the filter disclosed in U.S. Pat. No. 5,232,595 to Meyer. Although there is a mathematical relationship that suggests that the ideal relationship between the outer and inner periphery or diameter is 2:1 when known traditional pleats are used, in actual practice, a ratio of 1.5 to 1 leads to a more even pleat compression. When a 2:1 ratio is used, the outer pleats still show evidence of radial spreading, and an additional area gain can be realized with a multi-pleat. When a ratio of 1.5:1 is used, minimal radial spreading occurs and the use of a W pleat approach yields almost no practical gain in area. In the depicted embodiment d4 generally describes the inner diameter of the outer pleated filter element 18. The above-described configuration (FIG. 1) results in the distal ends 20 from the central axis of the pleats maintaining their general location when the filter being used or assembled. In addition, it generally results in a configuration where the available filter space is efficiently occupied with filter media. As will be described in further detail below, pleating arrangements larger than 1.5:1 ratios (e.g., 1.6:1) can result in a configuration where the distal ends 20 of the pleats move during operation and assembly within the filter more than is typically desired, or can result in a configuration where a substantial amount of the filter space is not occupied with filter media.

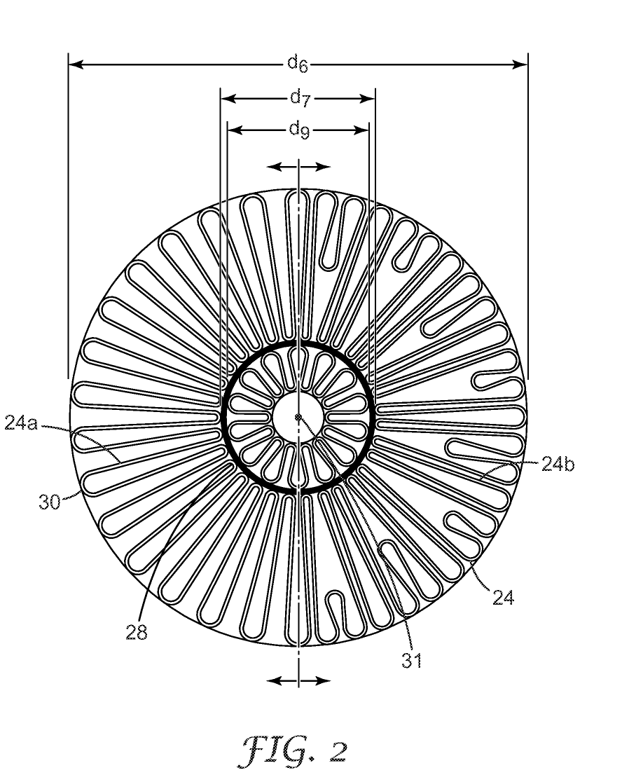

Referring to FIG. 2, a filter element is schematically illustrated wherein the outer diameter d6 of the outer filter element 24 is three times the size of the inner diameter d7 of the outer filter element 24 (i.e., a 3:1 ratio). In the depicted embodiment the outer filter element 24 is shown having a first pleating configuration 24a on the left side and a second pleating configuration 24b on the right side. In the depicted embodiment d7 describes the inner diameter of the outer filter element 24. However, it should be appreciated that in alternative embodiments the inner diameter of the outer filter element 24 and the outer diameter of the inner filter element 26 can also be substantially different. For example, in some embodiments a space or filler material (e.g., filter media housing) can be provided between the inner filter element 26 and the outer filter element 24.

The left side of FIG. 2 depicts a pleating configuration employing radial pleats wherein the proximal ends 28 of the pleats are adjacent one another and the distal ends 30 are substantially spaced apart. This arrangement may be desirable in some embodiments. However, in most embodiments it is desirable to avoid having substantial spaces between the distal ends 30, as spaced apart distal ends can move during operation and assembly. Also, the spaces between the distal ends 30 can, as described above, evidence an inefficient use of filter space, as it is generally desirable to maximize the amount of filter media within the filter element.

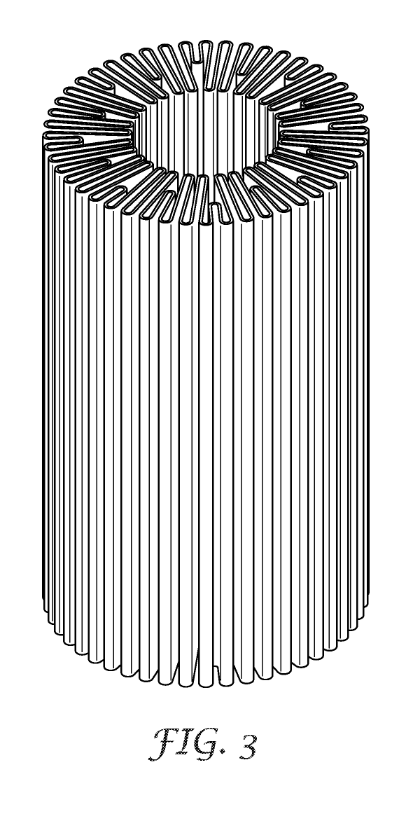

The right side of FIG. 2 depicts an alternative pleating configuration wherein more of the filter space is filled with filter media. The right side of the outer filter element 24 includes a pleating configuration that includes shorter radially inwardly extending secondary pleats arranged between longer outwardly extending primarily pleats. The shorter pleats have a length that is less than the length of the longer pleats. In the depicted embodiment the longer pleats have a length that is generally equal to half the distance between d6 and d7. It should be appreciated that in other embodiments the longer pleats may be longer or shorter than the distance between the inner periphery and the other periphery edge of the filter element. More particularly, in the depicted embodiment the pleating geometry of the outer filter element 24 is similar to the pleating geometry described in U.S. Pat. No. 6,315,130 to Olsen and US 2006/0107639 to Hamlin et al., which are both incorporated by reference in their entirety herein. The W-pleat and the pleat style disclosed in the above references may be considered to be multi-pleat. FIG. 3 is a perspective view of a filter element 32 having a pleating configuration disclosed and described in greater detail in U.S. Pat. No. 6,315,130.

In designing a filter product, it is commonly preferred to incorporate more than one layer of filter media with each layer having a different character to improve the overall filtration performance. However, if these two layers are co-pleated, then the filter area of the upper media will automatically be the same as the filter area of the lower layer. A co-pleated configuration does not allow for deviation from this 1:1 ratio. Depending upon the ultimate filter application, there may be a need for the prefilter area to be considerably greater or less than the final filter area. If the filter media are arranged instead as an inner and outer filter element, as previously described as concentric filter elements, then the ratio of the area of the prefilter media to the area of the final filter may deviate substantially from 1:1. A filter with concentric filter element using only traditional radial pleats will also limit the desired ratio to some prescribed amount. However, if a multipleat approach is used instead then other ratios can be realized. With any filter, other design constraints exist. The core size may be dictated by flow considerations. If the core is too small, it may not allow adequate egress of fluid flow from the element. If it is too large, then filtration area could be lost. The outer cage size will be dictated by space considerations. If it is too large, then it may not fit into the space reserved for it. Filters tend to be installed in locations where space is limited, and this design consideration is almost always present.

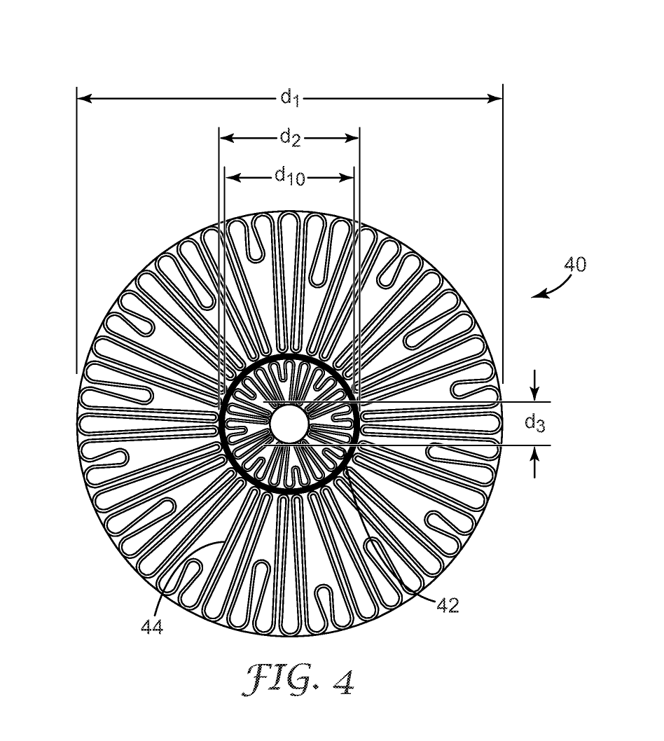

Employing nontraditional pleating configurations, which have been used in single filter element systems, to a concentric filter arrangement can be advantageous. In some embodiments it can result in successful combinations of different filtering media that are otherwise not possible or practical. For example, two very dissimilar filtering materials may be difficult to combine in a concentric arrangement employing a traditional pleating configuration (i.e., 1.5:1 ratio), as the useful life of each filter elements would be substantially different and may lead to failure of one filter element while the other filter element is still viable. Combining filter elements with substantially different useful lives can be undesirable, as the useful life of the filter system would be limited by the filter element with the shortest useful life. It is therefore typically more desirable to have the ability to tailor filter systems that combine multiple elements with similar useful lives. The present disclosure enables more of such combinations as the area of the pleated element in the inner and outer filter element can be varied more widely than would otherwise be feasible. In some embodiments, the surface area of the pleated element in the inner element is between 0.2 and 5 (in some embodiments, between 0.4 to 3; 0.5 to 2, or even 0.7 to 1.5) times the surface area of the outer element. The desired ratio will depend on a number of factors, including, for example, the target fluid to be filtered and properties of the filter media. Employing the principles of the present disclosure the ratio of diameters of the outer filter media and the inner filter media may be varied through a wide range (e.g., 1.6:1, 1.7:1, 1.8:1, 1.9:1, 2.0:1, 2.2:1, 2.4:1, 2.6:1, 2.8:1, 3.0:1, 3.5:1, 4:1, 5:1, 6:1, 7:1, 8:1, 9:1, 10:1). Since the principles of the present disclosure enable the ratio in areas and diameters to be adjusted over a broader range, more material combinations can be used in the filter construction. Referring to FIG. 4, another alternative embodiment of a filter arrangement 40 according to the present disclosure is shown. In the depicted embodiment both the inner filter element 42 and the outer filter element 44 include a nontraditional pleating configuration. In the depicted embodiment the diameter d1 is greater than twice the diameter d2, and the diameter d2 is greater than twice the diameter d3. The depicted embodiment illustrates that the amount of filtering media in each of the inner and outer elements 42, 44 can be tailored to the particular objective of the filter, as the ratio between the inner and outer diameters of the filter elements can vary through a wide range while still making efficient use of the filter space and avoiding loose distal ends of the pleats.

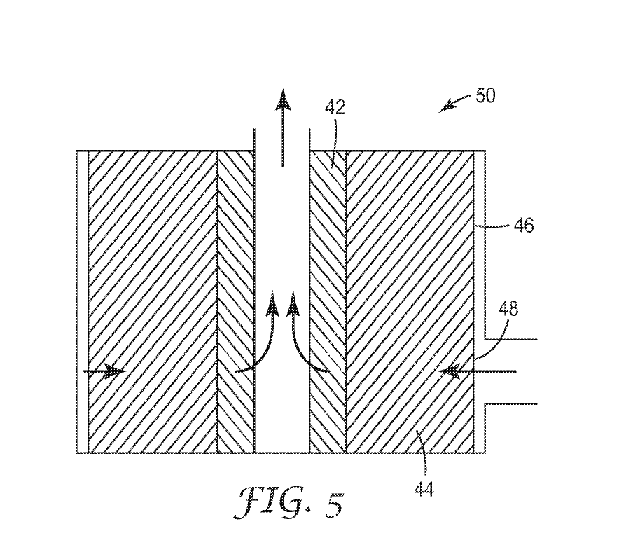

FIG. 5 depicts a concentric filter arrangement 50 within a housing 46 that directs fluid flow from the outside side surface 48 of the outer filter element 44 through the pleated filter media into the center portion of the inner filter element 42.

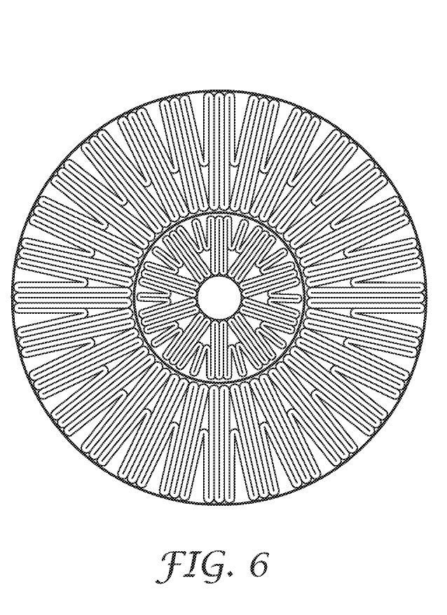

FIG. 6 depicts a portion of a concentric filter arrangement according to the present disclosure wherein the pleats are shown packed together as they would typically be in a commercial system. It should be appreciated that the pleats in prior figures are schematically illustrated with larger spaces therebetween for illustrative purposes.

In example embodiments, a filter product with an inner filter element and an outer filter element may be constructed of materials as shown in Table 1 below. Ignoring the potential for support or media compression, the thickness of both pleat legs would typically be double the total thickness of the various supports and filter media.

TABLE 1
Materials of Construction for Filter Product

| | | | Thickness |
|---|---|---|---|
| | | | mils |
| | Description | Material | (nominal) |
| Outer Filter | Upstream Support | Delstar Delnet RC707-24P | 5 |
| Element | | | |
| | Filter Media | Lydall 9104-D | 17 |
| | Filter Media | LifeASSURE BLA080 | 8 |
| | Downstream | BBA Reemay 2011 | 8 |
| | Support | | |
| Total Media Thickness (both legs) | | | 76 |
| Inner Filter | Upstream Support | BBA Typar 3091L | 8 |
| Element | | | |
| | Membrane | CUNO SterASSURE | 12 |
| | PSA020 | | |
| | Downstream | BBA Typar 3091L | 8 |
| | Support | | |
| | Second | Delstar Delnet RC707-24P | 5 |
| | Downstream | | |
| | Support | | |

| | |
|---|---|
| Total Media Thickness (both legs) | 66 |

The primary pleat contribution may be easily calculated from the following:

Pleat height=(Outer diameter-Inner diameter)/2

Pleat count=(Inner circumference)/(total media thickness both legs)

Area=Pleat height*2*Pleat count*filter length

The secondary pleat contribution is more complicated but calculation can be visualized graphically as a trapezoid where one of the vertical sides is orthogonal to the upper and lower horizontal sides. The lower and shorter side on the trapezoid would correspond to the circumference of the inner diameter of the filter element. The upper and longer side of the trapezoid would correspond to the circumference of the outer diameter. Such a trapezoid could be further subdivided as a rectangle and a triangle by drawing a line on the lower horizontal side but opposite of the orgothonal vertical side but parallel to the first vertical orthogonal side. The vertical orthogonal side would correspond the primary pleat height. The rectangle would correspond to the contribution of the primary pleat. The triangle would correspond to the portion of the secondary pleats. Theoretically, the triangle would represent pleat heights diminishing to the point of no height, which is not practical in reality. In U.S. Pat. No. 6,315,130, it was suggested that only ⅔ of the excess circumference (which is ⅔ of the difference between the upper and lower side of the trapezoid) could be used before the pleats became impractically short. The limit is empirical as it is a function of the pleat thickness, media pliability and other factors, but some limit will always exist so that same limit will be used for the calculations below. Although the secondary pleats will vary in height, for ease of calculation they may be represented by some average height. If pleat heights of all lengths could be used, then that height would be ½ the primary pleat height. However, since only the first ⅔ of the pleat heights can be used, and it is the shortest pleats that are eliminated, the average will be greater than ½ the primary pleat height For ease of calculation, ½ will be used.

Therefore the equations for Multi-pleat per U.S. Pat. No. 6,315,130 would be as follows:

Primary Pleat height=(Outer diameter−Inner diameter)/2

Primary Pleat count=(Inner circumference)/(total media thickness both legs)

Secondary Pleat height=½*((Outer diameter−Inner diameter)/2)

Secondary Pleat count=(Outer circumference−Inner circumference)*0.67/(total media thickness both legs)

Total Area=(Primary pleat height*2*Primary pleat count*filter length)+(Secondary pleat height*2*Secondary pleat count*filter length)

Table 2 below summarizes some examples that show that by varying the outer periphery of the inner filter element, it is possible to vary the ratio of areas for the multipleat design. Example 1 shows a conventional radial approach for a specific set of diameters for the inner and outer filter element. Examples 2 and 4 show how the multipleat can easily bracket the conventional radial pleat approach in terms of varying area. Example 3 shows that in order to vary the area ratio of a conventional radial approach, it is necessary to vary the overall dimensions of the filter. Varying the design in this manner can also lead to spreading of the pleats which are disadvantageous during assembly and use.

TABLE 2
Examples of Different Concentric Filter Product Assemblies

| | Example 1 | Example 2 | Example 3 | Example 4 |
|---|---|---|---|---|
| Inner Filter Element | | | | |
| Inner Diameter (inches) | 0.96 | 0.96 | 0.96 | 0.96 |
| Inner Circumference | 3.02 | 3.02 | 3.02 | 3.02 |
| (inches) | | | | |
| Outer Diameter (inches) | 1.96 | 1.96 | 2.31 | 1.63 |
| Outer Circumference | 6.16 | 6.16 | 7.25 | 5.11 |
| (inches) | | | | |
| Pleat Style | radial | multipleat | radial | multipleat |
| Total Media Thickness | 0.066 | 0.066 | 0.066 | 0.066 |
| (both legs) (inches) | | | | |
| Filter Length (inches) | 9.2 | 9.2 | 9.2 | 9.2 |
| Pleat Height (primary | 0.50 | 0.50 | 0.67 | 0.33 |
| portion) (inches) | | | | |
| Number of Pleats | 46 | 46 | 46 | 46 |
| (primary portion) | | | | |
| (inches) | | | | |
| Pleat Height (secondary | 0 | 0.25 | 0 | 0.17 |
| pleat portion from | | | | |
| 6,315,130) (inches) | | | | |
| Number of Pleats | | 32 | | 21 |
| (secondary pleat portion) | | | | |
| Area (Inner Filter | 423 | 570 | 570 | 634 |
| Element) in² | | | | |
| Outer Filter Element | | | | |
| Inner Diameter (inches) | 2 | 2 | 2.35 | 1.67 |
| Inner Circumference | 6.28 | 6.28 | 7.37 | 5.23 |
| (inches) | | | | |
| Outer Diameter (inches) | 3.5 | 3.5 | 3.95 | 3.5 |
| Outer Circumference | 11.00 | 11.00 | 12.42 | 11.00 |
| (inches) | | | | |
| Pleat Style | radial | multipleat | radial | multipleat |
| Total Media Thickness | 0.076 | 0.076 | 0.076 | 0.076 |
| (both legs) (inches) | | | | |
| Filter Length (inches) | 9.2 | 9.2 | 9.2 | 9.2 |
| Pleat Height (primary | 0.75 | 0.75 | 0.80 | 0.92 |
| portion) (inches) | | | | |
| Number of Pleats | 83 | 83 | 97 | 69 |
| (primary portion) | | | | |
| (inches) | | | | |
| Pleat Height (secondary | 0 | 0.375 | 0 | 0.459 |
| pleat portion from | | | | |
| 6,315,130) (inches) | | | | |
| Number of Pleats | | 42 | | 51 |
| (secondary pleat portion) | | | | |
| (inches) | | | | |
| Area (Inner Filter | 1145 | 1435 | 1435 | 1865 |
| Element) in² | | | | |
| Ratio of Inner and Outer | 2.71 | 2.52 | 2.52 | 2.94 |
| Filter Element Area | | | | |

The above specification, examples and data provide a complete description of the manufacture and use of the composition of the invention. Since many embodiments of the invention can be made without departing from the spirit and scope of the invention, the invention resides in the claims hereinafter appended.

1. A cylindrical filter arrangement comprising:
a first filter element;
a second filter element,
wherein at least one of the first or second filter elements comprises a plurality of radially outwardly extending primary pleats positioned between radially inwardly extending secondary pleats, wherein at least some of the inwardly extending secondary pleats are shorter than some of the outwardly extending primary pleats, wherein at least some of the inwardly extending secondary pleats are of different lengths; and
wherein the first and second filter elements are generally cylindrical and are concentrically arranged such that at least a portion of the second filter element surrounds at least a portion of the first filter element.

2. The filter of claim 1, wherein an outer diameter of the second filter element is at least about 1.6 times as large as the inner diameter of the second filter element.

3. The filter of claim 1, wherein an outer diameter of the second filter element is at least about 1.6 times as large as the outer diameter of the first filter element.

4. The filter of claim 1, wherein the second filter element comprises a plurality of radially outwardly extending primary pleats positioned between radially inwardly extending secondary pleats, wherein at least some of the inwardly extending secondary pleats are shorter than some of the outwardly extending primary pleats, wherein at least some of the inwardly extending secondary pleats are of different lengths.

5. The filter of claim 4, wherein the first filter element comprises a plurality of radially outwardly extending pleats that are about the same length.

6. The filter of claim 4, wherein the first filter element comprises a plurality of radially outwardly extending primary pleats positioned between radially inwardly extending secondary pleats, wherein at least some of the inwardly extending secondary pleats are shorter than some of the other outwardly extending primarily pleats, wherein at least some of the inwardly extending secondary pleats are of different lengths.

7. The filter of claim 4, wherein an outer diameter of the second filter element is at least about two times the outer diameter of the first filter element.

8. The filter of claim 4, wherein an outer diameter of the second filter element is at between about 3 to about 5 times greater than the outer diameter of the first filter element.

9. The filter of claim 1, wherein the surface area of the first filter element is between about 0.7 to about 1.5 times the surface area of the second filter element.

10. The filter of claim 1, further comprising a housing configured to direct the flow of fluid between the outside surface of the second filter element and a center opening in the first filter element.

11. (canceled)

12. A cylindrical filter arrangement comprising:
a first filter element;
a second filter element, wherein the second filter element comprises a plurality of radially outwardly extending primary pleats positioned between inwardly radially extending secondary pleats, wherein at least some of the inwardly extending secondary pleats are shorter than some of the outwardly extending primary pleats, wherein at least some of the inwardly extending secondary pleats are of different lengths;
wherein the first and second filter elements are generally cylindrical and concentrically arranged;
wherein the first filter element comprises a material having an average pore size that is greater the average pore size of the material used in the second filter element.

13. A method of manufacturing a filter comprising:
providing a first filter element;
providing a second filter element, wherein the second filter element comprises a plurality of radially outwardly extending primary pleats positioned between inwardly radially extending secondary pleats, wherein at least some of the inwardly extending secondary pleats are shorter than some of the outwardly extending primary pleats, wherein at least some of the inwardly extending secondary pleats are of different lengths;
arranging the second filter element concentrically around the first filter element; and
configuring the first and second filter elements such that their estimated effective lives are about the same for the type of fluid to be filtered.

14. The method of claim 13, wherein the estimated effective life of the first and second filter elements are within 10 percent of each other.

15. The method of claim 13, wherein the step of configuring the first and second filter elements includes selecting a second filter element having a surface area that is about the same as the surface area of the first filter element.

16. The method of claim 13, wherein the outer diameter of the second filter element is greater than about 1.6 times the outer diameter of the first filter element.

17. A cylindrical filter arrangement comprising:
a first filter element;
a second filter element,
wherein the first and second filter elements are generally cylindrical and are concentrically arranged such that at least a portion of the second filter element surrounds at least a portion of the first filter element;
a housing configured to direct the flow of fluid between the outer side surface of the second filter element and a center opening in the first filter element;
wherein an outer diameter of the second filter element is at least twice as large as the inner diameter of the second filter element and the outer diameter of the first filter element;
wherein the first and second filter elements comprise a plurality of radially outwardly extending primary pleats positioned between radially inwardly extending secondary pleats;
wherein at least some of the inwardly extending secondary pleats are shorter than some of the outwardly extending primary pleats;
wherein some of the secondary pleats vary in length; and
wherein the first filter element comprises a material having an average pore size that is different than the average pore size of the material used in the second filter element.
